(19) United States
(12) Patent Application Publication
(10) Pub. No.: US 2004/0025651 A1
(43) Pub. Date: Feb. 12, 2004

(54) Cheese slicer

(76) Inventors: Linda J. Bachman, Cambridge, MN (US); Marvin A. Koolmo, Cambridge, MN (US)

Correspondence Address: PATENT DEPARTMENT, LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 10/213,758

(22) Filed: Aug. 7, 2002

(51) Int. Cl. B26D 1/00; B26D 3/00; A21C 5/08; A21C 15/04; A21C 5/00; B26B 3/00

(52) U.S. Cl. 83/13; 83/932; 30/114; 30/116; 30/280

(57) ABSTRACT

An apparatus for slicing a food product into a plurality of slices in one action. The apparatus includes a frame having a first end, a second end and a body portion having an opening therein, the body portion having a plurality of spaced apart cutting strands disposed across the opening that are operably supported by the body portion of the frame. In use, the body portion of the apparatus is disposed in a substantially vertical alignment over at least a portion of a food product, and forced downwardly such that the plurality of spaced apart cutting strands across the opening slices the food product into a plurality of individual slices in one action.

### BACKGROUND

Food products such as cheese and butter are sometimes sold in bars or blocks. To obtain a suitable slice of these products for consumption or use in preparing dishes such as hamburgers, buffet tables, snack packs and the like, one has to slice the bar or block of cheese into thin or manageable slices. Often times, there is need to prepare several slices at a time. The use of traditional tools such as knives to slice these food products are commonplace in homes, restaurants and the like. However, most of these traditional tools are designed to only slice single pieces at a time, thus making it tedious when a plurality of slices are needed.

Various types of cheese slicers have been devised, such as disclosed in U.S. Pat. Nos. 6,009,786 (Hjelden), 6,244,150 (Holcomb, et. al.), D446,697 (Bodum). Unfortunately, these devices are not usable to form multiple slices of food products such as cheese. Operators such as hoteliers, deli owners and other restaurateurs are constantly looking for ways to improve their cost, and efficiency through the production cycle between orders and presentation of the ordered dish to the customer.

From the foregoing, it will be appreciated that what is needed in the art is a food product slicer that is economical, durable, and usable to form several slices of such food products in a single motion.

### SUMMARY

The present invention provides an apparatus for slicing a food product into a plurality of slices in one action. The apparatus comprises a frame, having a first end, a second end and a body portion disposed between the first and second ends. The body portion includes an opening therein, having a plurality of spaced apart cutting strands disposed across the opening and operably supported by the body portion of the frame. In use, the opening in the body portion is disposed in substantial vertical alignment over at least a portion of a food product desired to be sliced, the frame then being forced downwardly such that the plurality of spaced apart cutting strands across the opening slices the food product into a plurality of individual slices in one action.

### BRIEF DESCRIPTION OF THE DRAWINGS

FIG. 1 is a top plan view of the preferred embodiment of the apparatus of the present invention.

FIG. 2 is a bottom plan view of the preferred embodiment of the apparatus of the present invention.

FIG. 3 is a side elevation view of the preferred embodiment of the apparatus of the present invention.

FIG. 4 is a bottom plan view of another embodiment of the apparatus of the present invention.

FIG. 5 is a partial cross-sectional view of another embodiment of the apparatus of the present invention.

### DETAILED DESCRIPTION

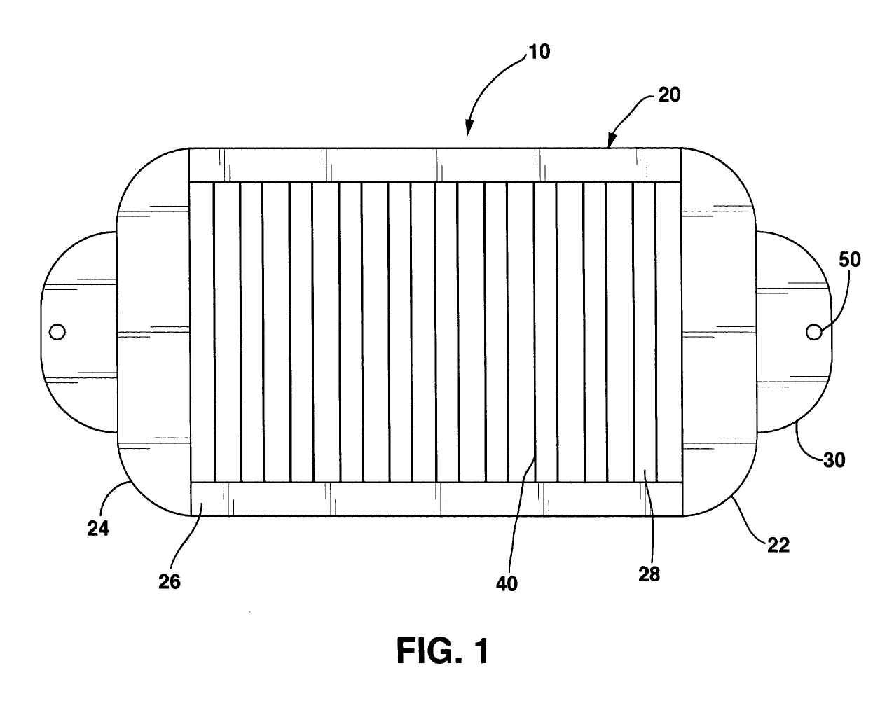

Drawing FIGS. 1-3 illustrate a preferred embodiment of the apparatus 10 of the present invention for cutting or slicing food products such as blocks of cheese or butter; baked goods, including cakes, bread dough or loaves of bread; fruits and vegetables; or any other food product from which it is desired to obtain a plurality of slices. The apparatus 10 comprises a frame 20 having a first end 22, a second end 24, and a body portion 26. The body portion 26 includes an opening 28 therein. The opening 28 includes a plurality of spaced apart cutting strands 40 that are operably supported by the body portion 26 of the frame 20.

In the preferred embodiment, the frame 20 is substantially rectangular. However, the frame 20 may be any shape, including square, oval, circular, or any other desired shape. Additionally, the frame 20 may be formed from a single or multiple pieces of material, and may be made of any substantially rigid material including wood, synthetic composite material, plastic, metals, other natural materials such as ivory, and/or combinations thereof. It is also contemplated that the frame 20 may be decorated, artistically carved, and/or imaged for any reason, including aesthetics, taste, impression, and the like. If the frame 20 is comprised of a combination of multiple pieces, it is desirable to ensure the combination of pieces are securely connected together to prevent premature dismantling during use, or other unintended results such as warping of the frame 20. Such connecting arrangements may be accomplished by use of screws, preformed locking mechanisms, and/or suitable coupling devices.

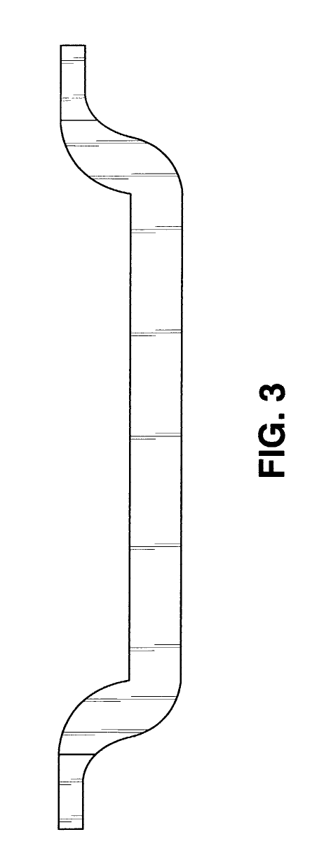

The apparatus may be flat, canted or beveled as shown in the side elevation view of FIG. 3. The first and second ends 22, 24 of the frame 20 may be provided with grips or handles 30 that allow for handling the apparatus of the present invention. The handles 30 preferably extend outwardly from the body portion 26 operably supporting the spaced apart cutting strands 40, and may have any desirable or practical shape. Rather than extending outwardly, the handles 30 may alternatively be disposed vertically above the body portion 26 of the frame or in any other direction as desired to control physical contact by a user of the apparatus 10 with the food product being sliced. Similarly, an elongated handle may be secured to the apparatus 10 if desired. The handles 30 may be fitted with a hook, clamp, or opening suitable for hanging. Such an opening 50 is shown in FIG. 1.

In the preferred embodiment, the opening 28 in the body portion 26 of the frame 20 is substantially rectangular. However, it should be appreciated that the opening 28 may be any shape including oval, circular, square, or any desired shape.

In the preferred embodiment, the cutting strands 40 are stainless steel wires as typically found in conventional cheese slicers. It should be appreciated, however, that the cutting strands 40 may be any suitable device capable of cutting and slicing food product such as smooth or serrated blades or knives, wires, or threads. Furthermore, the cutting strands may be made of any suitable material including steel, plastic, organic or synthetic fibers or composite material, or any combination thereof. Such materials only being limited by the capability to cut a food product without requiring undue replacement of the strands due to breaking, deformation or undue slacking. Furthermore since the cutting strands 40 may come in contact with food or items for human consumption, the strands may be coated, polished, or otherwise shielded to prevent contamination of the food or item, and for ease of cleaning.

It should also be appreciated that the cutting strands 40 may be disposed transversely, longitudinally, diagonally, or in more than one direction across the opening 28 in the body portion 26 of the apparatus 10 depending on the size and desired shape of the individual slices to be cut.

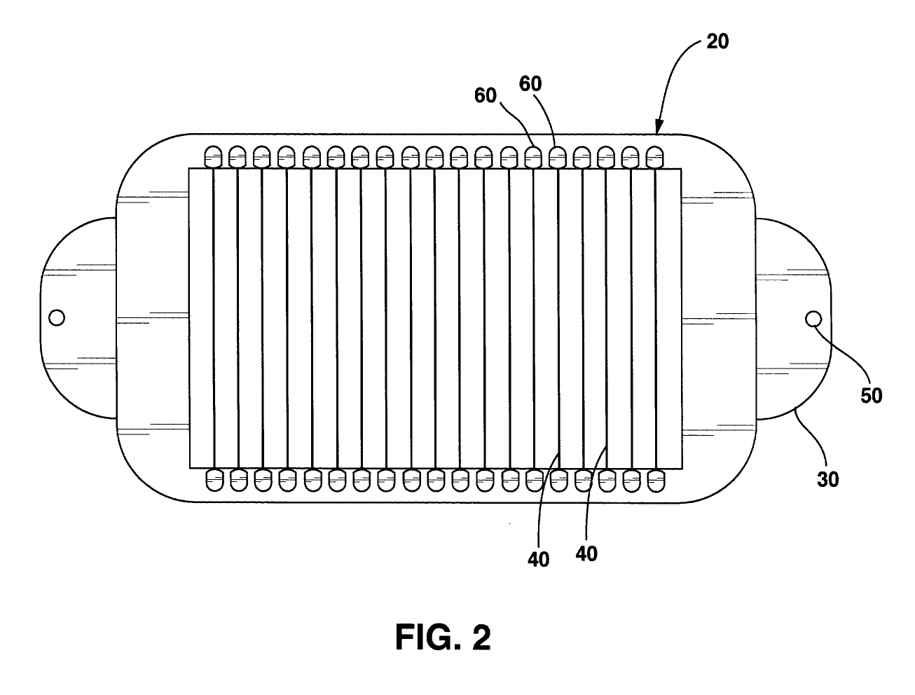

FIG. 2 is a bottom plan view of the preferred embodiment of the apparatus 10 of the present invention. As can be seen in FIG. 2, disposed on each side of the opening 28 is a plurality of spaced securing mechanisms 60 for securing the cutting strands 40 to the frame 20. The cutting strands 40 are preferably tensioned or securely attached to prevent undue slacking, premature loosening, and the like.

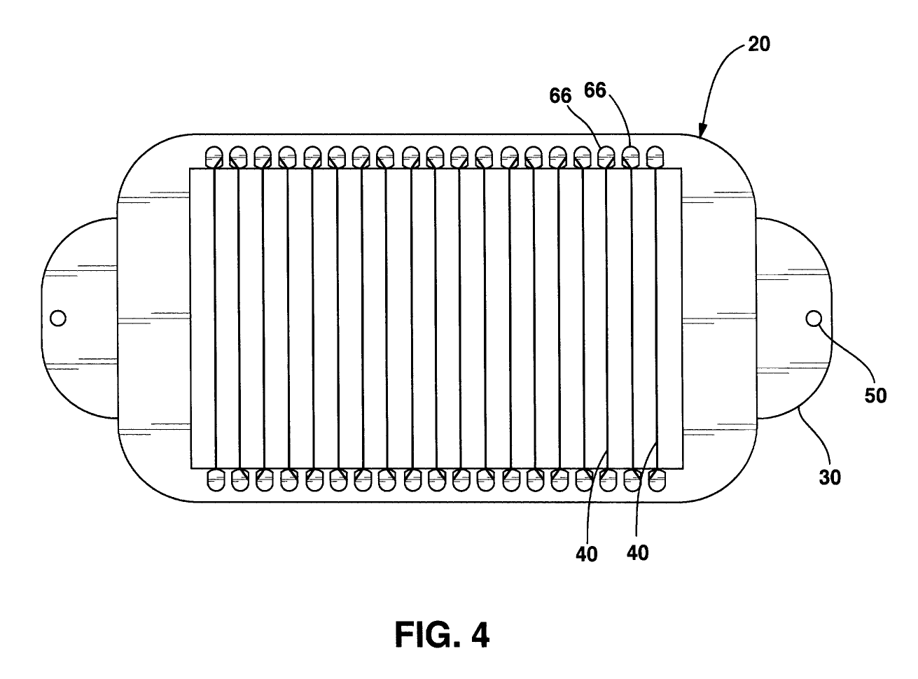

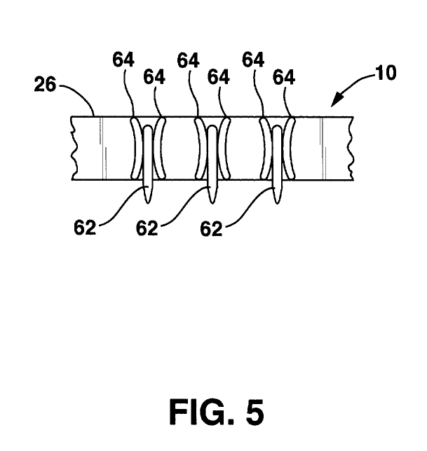

The securing mechanisms 60 may be hooks, holes, clamps, loops, gussets, and the like, depending on the type of cutting strands 40 used. Additionally, it may be desirable to incorporate a combination of securing mechanisms on one or more sides of the frame 20. In the preferred embodiment, the preferred stainless steel wire cutting strands are secured to the body portion 26 of the frame 20 by securing mechanisms 60 as found in the conventional cheese slicers such as disclosed in U.S. Pat. No. D446,697 (Bodum), the disclosure of which is incorporated herein by reference. In an alternative embodiment as shown in FIG. 4, the cutting strands 40 may be comprised of a continuous wire looped through the securing mechanisms 60 comprising holes. In yet another embodiment, as shown in FIG. 5, wherein the apparatus 10 includes cutting strands 40 comprised of blades 62, the securing mechanism 60 may be a gusset 64 adapted to removably receive the cutting blade. In yet another embodiment (not shown), the cutting strands 40 may be comprised of individual wires secured by securing mechanisms 60 or continuous wire looped through holes, with one end of the body portion 26 being removably attached to the frame 20.

The desired spacing of the cutting strands 40 may depend on the desired food product to be sliced. For example, the spacing of the cutting strands may be relatively close for producing slices of cheese, or wider for slicing vegetables of fruit. Accordingly, it may be desirable to be able to selectively remove one or more spaced apart cutting strands from the body portion 26 of the frame 20 to provide a desired slice or piece of food product.

It should be appreciated that the body portion 26 of the apparatus 10 of the present invention may also comprise a cutting strand in which the inside edge of the opening 28 may provide an edge to cut a food product into a slice or piece depending on the dimensions of the opening 28 in the body portion 26 of the apparatus 10.

In operation, the opening 28 of the apparatus 10 is placed in substantial vertical alignment over at least a portion of a food product desired to be sliced. The apparatus 10 is then pushed downwardly over the food product. The cutting strands cut the food product into a plurality of slices in one action.

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

What is claimed is:

1. An apparatus for slicing a food product into a plurality of slices in one action, comprising:
a frame, having a first end, a second end and a body portion disposed between the first and second ends, the body portion having an opening therein; and
a plurality of spaced apart cutting strands disposed across the opening and operably supported by the body portion of the frame;
whereby in use, the opening in the body portion is disposed in substantial vertical alignment over at least a portion of a food product desired to be sliced, the frame then being forced downwardly such that the plurality of spaced apart cutting strands across the opening slices the food product into a plurality of individual slices in one action.

2. The apparatus of claim 1, wherein the first and second ends include handles.

3. The apparatus of claim 1, wherein the spaced apart cutting strands are disposed transversely across the opening in the body portion.

4. The apparatus of claim 1, wherein the spaced apart cutting strands are disposed longitudinally across the opening in the body portion.

5. The apparatus of claim 1, wherein the spaced apart cutting strands are disposed diagonally across the opening in the body portion.

6. The apparatus of claim 1, wherein spaced apart cutting strands are disposed in more than one direction across the opening in the body portion.

7. The apparatus of claim 1, wherein the opening is substantially rectangular.

8. The apparatus of claim 1, wherein the opening is substantially square.

9. The apparatus of claim 1, wherein the opening is substantially oval.

10. The apparatus of claim 1, wherein the opening is substantially circular.

11. The apparatus of claim 1, wherein the spaced apart cutting strands are equally spaced.

12. The apparatus of claim 1, wherein the spaced apart cutting strands are tensioned.

13. The apparatus of claim 1, wherein the spaced apart cutting strands are removable from the body portion of the frame.

14. The apparatus of claim 1, wherein a securing mechanism secures the cutting strands to the body portion of the frame.

15. The apparatus of claim 1, wherein the body portion of the frame is a cutting strand.

16. A method for slicing a food product into a plurality of slices in one action, comprising the steps of:
(a) providing an apparatus comprising:
(i) a frame, having a first end, a second end and a body portion disposed between the first and second ends, the body portion having an opening therein, and
(ii) a plurality of spaced apart cutting strands disposed across the opening and operably supported by the body portion of the frame,
(b) aligning the opening in the body portion of the apparatus substantially vertically over at least a portion of a food product desired to be sliced, and
(c) forcing the frame of the apparatus downwardly such that the plurality of spaced apart cutting strands across the opening slices the food product into a plurality of individual slices in one action.
